(19) United States
(12) Patent Application Publication
(10) Pub. No.: US 2021/0071797 A1
(43) Pub. Date: Mar. 11, 2021

(54) Apparatus and Method for Providing Access to Buried Pipeline

(71) Applicant: LMK Technologies, LLC, Ottawa, IL (US)

(72) Inventor: Rick Gage, Ottawa, IL (US)

(73) Assignee: LMK Technologies, LLC, Ottawa, IL (US)

(21) Appl. No.: 16/561,135

(22) Filed: Sep. 5, 2019

(51) Int. Cl. F16L 47/30; E03F 3/04

(52) U.S. Cl. CPC F16L 47/30; E03F 3/04

(57) ABSTRACT

The pipe access device is comprised of a curved plate adapted to engage an underground pipe along an arc of the outer surface of the pipe, and a boss extending upwardly from the curved plate about an aperture in the curved plate. The boss is adapted to receive an extension pipe. The boss includes a flange adapted to engage ad end of the extension pipe. A gasket is combined with the flange to help seal the connection between the boss and the extension pipe. The pipe access device is for use in providing access to the buried pipe that requires minimal excavation and disruption of the soil.

### BACKGROUND

The present invention relates to an apparatus and method for providing access to a buried pipe, such as a sewer pipe and the like.

Conventional sewer lines include a main pipe which extends along the street in a direction parallel to the street. Each house has a lateral pipeline that extends from the home and connects to the main pipeline. It is often desirable to provide a clean-out to the lateral pipe adjacent the main sewer pipe. Many lateral pipes have been buried without such a clean-out. In order to provide a clean-out, it is necessary to make a wide and extensive excavation so that persons can enter the excavation and attach a clean-out pipe to the lateral pipe. This results in considerable disruption to the soil and the yard around the house.

Existing devices have been created to allow access to a buried pipeline without requiring a full and extensive excavation. Some of these existing devices are described in U.S. Pat. No. 6,705,801 (Kiest) issued Mar. 16, 2004, U.S. Pat. No. 9,151,410 (Kiest) issued Oct. 6, 2015, and U.S. patent application Ser. No. 16/208,140 (Kiest) filed Dec. 3, 2018, all of which are hereby expressly incorporated by this reference. Generally, these existing devices include an access assembly having a curved plate combined with at least one upstanding boss with an aperture therein. The curved plate is attached to the lateral pipe beneath the ground surface. An extension pipe extends down from the ground surface and is combined with each upstanding boss so that the aperture in the curved plate is in communication with the extension pipe. An access hole is cut in the upper side of the lateral sewer pipe to provide communication from the extension pipe (at ground level) to the interior bore of the lateral sewer pipe. The saddle is combined with the pipe by applying a downward force that causes the curved plate to engage the pipe. An adhesive such as a solvent weld or glue is used to help secure the extension pipe to the boss. A top view looking into an existing boss is shown in FIG. 5 wherein the flange 41 extends inwardly from the inner surface of the boss. A potential drawback to these existing assemblies is that the glue may become brittle or otherwise not form a water tight seal between the access assembly and the extension pipe.

Therefore, a primary object, feature and/ or advantage of the present invention is the provision of an improved apparatus and method for providing access to a buried pipe.

A further object, feature and/or advantage of the present invention is an apparatus and method for providing access to a buried pipe using a compressible sealing gasket between the access assembly and the extension pipe.

A further object, feature and/or advantage of the present invention is an apparatus and method for providing access to a buried pipe using a compressible hydrophilic or hydrophobic sealing gasket between the access assembly and the extension pipe.

A further object, feature and/or advantage of the present invention is an apparatus and method for providing access to a buried pipe using a compressible sealing gasket between the access assembly and the extension pipe which obviates the need to use an adhesive to combine the components together.

A further object, feature and/or advantage of the present invention is an apparatus and method for providing access to a buried pipe using a compressible sealing gasket between the access assembly and the extension pipe which is economical to manufacture, durable in use, and reliable in operation.

These and/or other objects, features and/or advantages of the present invention will become apparent with reference to the remainder of the specification and claims.

### SUMMARY

One aspect of the present invention includes an apparatus for providing access to an interior bore of a pipe located below a surface of the ground. The apparatus, referred to as a pipe access device, includes a curved plate (sometimes referred to as a saddle) having a concave surface and adapted to engage the pipe along an arc of the outer surface of the pipe. The apparatus also includes at least one boss extending upwardly from the curved plate about an aperture in the curved plate. Each boss is adapted to receive an extension pipe which extends between the boss and the ground surface or in another underground direction from the boss. The boss includes a flange protruding inwardly from an inner surface. The flange is adapted to seat an end of the extension pipe. A gasket is positioned on the flange to engaged an end of the extension pipe and create a seal between the flange and the end of the extension pipe. The gasket may be attached to the flange by an adhesive or any other suitable means. The gasket may be a compressible gasket made from a hydrophilic or hydrophobic material. A hydrophilic gasket is capable of expanding or swelling in response to being exposed to a liquid, such as water, and forms a seal between the boss and the extension pipe. An adhesive material may also be disposed between the curved plate and the outer surface of the pipe and/or between the boss and the extension pipe to assist in holding the components together.

In some embodiments the apparatus described above includes a boss with an oval-shaped cross-section that changes to a substantially circular cross-section when the curve plate is expanded or flexed to engage the pipe. Thus, once the pipe access device is secured to the pipe, a substantially circular extension pipe can easily telescope inside the boss.

Another aspect of the present invention includes a method of providing access to an interior bore of a pipe buried beneath the surface of the ground. The method generally includes excavating the ground to expose a portion of the pipe, taking a pipe access device as described previously, attaching the pipe access device to the pipe, cutting an access hole in the pipe aligned with a boss bore formed by the boss of the pipe access device, and mounting an extension pipe against the gasket within the boss to provide a fluid seal between the boss and the extension pipe as well as fluid communication between the buried pipe and the surface of the ground through the extension pipe. The pipe access device is attached to the pipe by pressing the curved plate downwardly onto the pipe.

The present invention contemplates using the pipe access device to provide access to many different kinds of pipelines, including, but not limited to mainline sewer pipelines, lateral sewer pipelines, gas pipelines, and potable water pipelines.

### BRIEF DESCRIPTION OF THE DRAWINGS

FIG. 1 is a sectional view showing a buried lateral and main sewer pipe and a pipe access device for providing access to the interior of the lateral sewer pipe.

FIG. 2 is a perspective partially exploded view of the device shown in FIG. 1.

FIG. 3 is a sectional view taken along line A-A of FIG. 1.

FIG. 4 is an exploded view similar to FIG. 3.

FIG. 5 is a top view of a prior art pipe access device showing the flange inside the boss adapted to receive an extension pipe.

FIG. 6 is a top view of the pipe access device showing a gasket combined with the flange inside the boss adapted to receive an extension pipe.

FIG. 7 is a perspective partially exploded view of an embodiment having more than one boss combined with the curved plate, each boss having a gasket combined with a flange for receiving an extension pipe.

### DETAILED DESCRIPTION

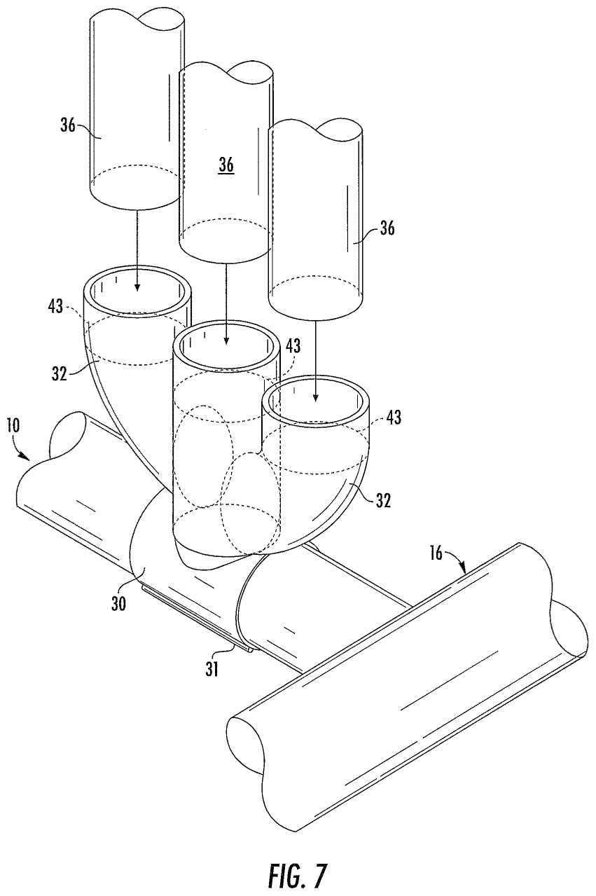

For exemplary purposes only, the present invention is described in detail with reference to providing access to a lateral sewer pipe 10. The present invention is equally applicable to both main pipes 16 and lateral sewer pipes 10 as well as other types of buried pipe. Further, for exemplary purposes only, the present invention is described primarily as having a single boss 32 extending upward from the curved plate 30. However, the invention also includes embodiments where there is more than one boss 32 extending upward from the curved plate as shown in FIG. 7, at least one boss 32 having the features described herein and adapted to receive an extension pipe 36.

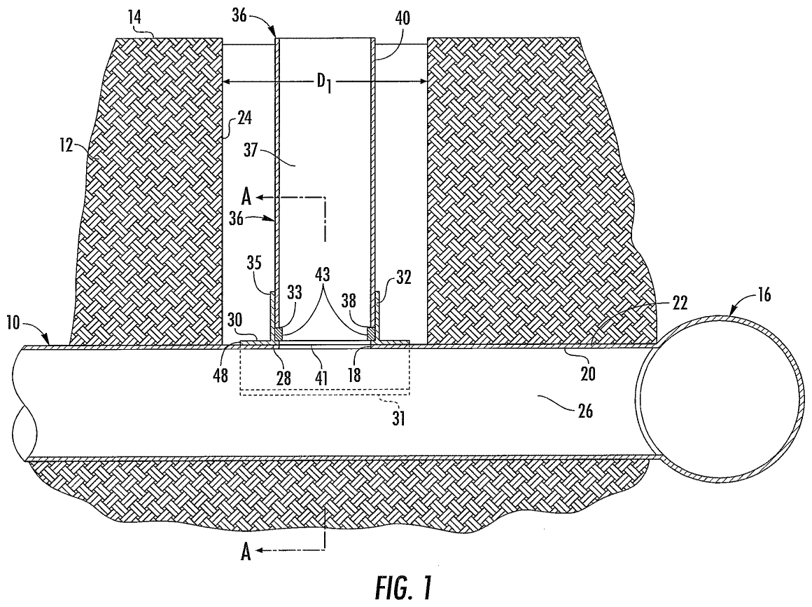

Referring to FIG. 1, a lateral sewer pipe 10 connected to a main sewer pipe 16 is buried beneath the ground 12 having an upper surface 14. An aperture 18 is cut in the lateral pipe 10 and provides access to an interior bore 26 of the pipe 10. Generally this is the last operation performed in providing access to the sewer pipe 10. The sewer pipe 10 includes an inner surface 20 and an outer surface 22 that extend along an arc corresponding to a central angle of 360°.

An excavated hole 24 is dug in the ground 12 from its upper surface 14 to a depth that exposes the sewer pipe 10. The hole 24 has a diameter D1 that provides access from the sewer pipe 10 up to the upper surface 14 of the ground 12, while minimizing disruption to the ground 12.

As best shown in FIGS. 1-3, a pipe access device 28 includes a curved plate 30 and a boss 32. The curved plate 30 has a first (top) side and a second (bottom) side. The boss 32 extends upwardly from the first side of the curved plate 30 and has a boss bore 34 extending therethrough. Boss bore 34 has a lower end 33 adapted to communicate with the sewer bore 26 through the aperture 18 and extending upwardly to an upper end 35. The second side of the curved plate 30 is adapted to engage the pipe 10 along an arc of the outer surface of the pipe 16. In some embodiments an adhesive material 66 may be disposed between the curved plate 30 and the outer surface of the pipe 10 to assist in holding the curved plate 30 on the pipe 10. In some embodiments the curved plate 30 and boss 32 may be made from PVC.

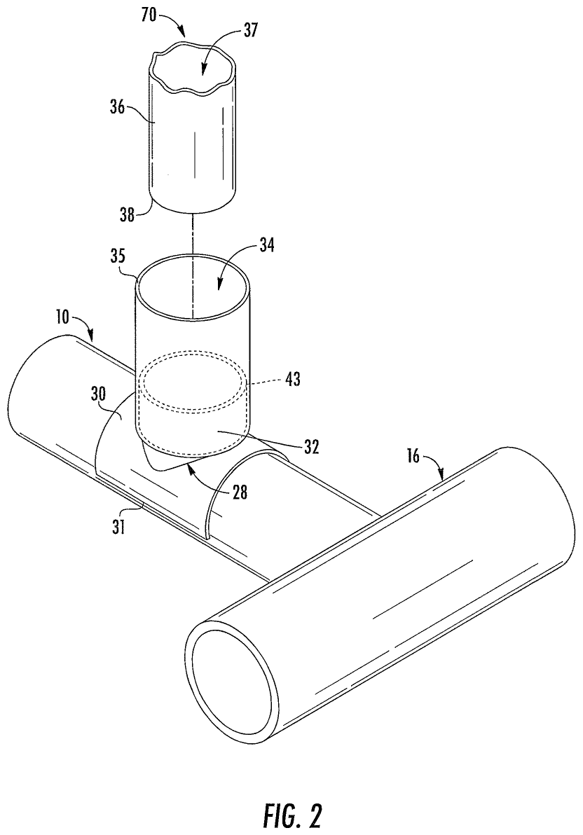

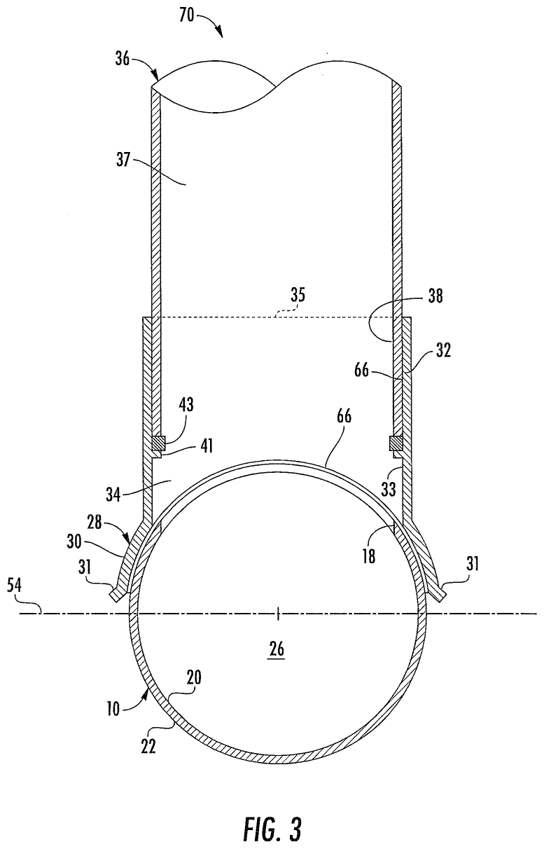

In some embodiments the curved plate 30 has a flange at its outer tips 31. The longitudinal centerline 54 (FIG. 3) or spring line of the sewer pipe 10 may be above or below the tips 31 of the curved plate 30. As shown in FIGS. 1 and 3, the outer tips 31 of the curved plate 30 extend along an arc associated with a central angle of less than 180°. Put another way, the concave surface 39 of the curved plate 30 spans an arc length of the outer surface 22 of the pipe 10 that is less than half of the circumference of the outer surface 22 of the pipe 10. In other embodiments, such as the ones shown in FIGS. 2 and 7, the tips 31 of the curved plate 30 extend beyond the spring line of the pipe 10 (more than 180° around the pipe 10).

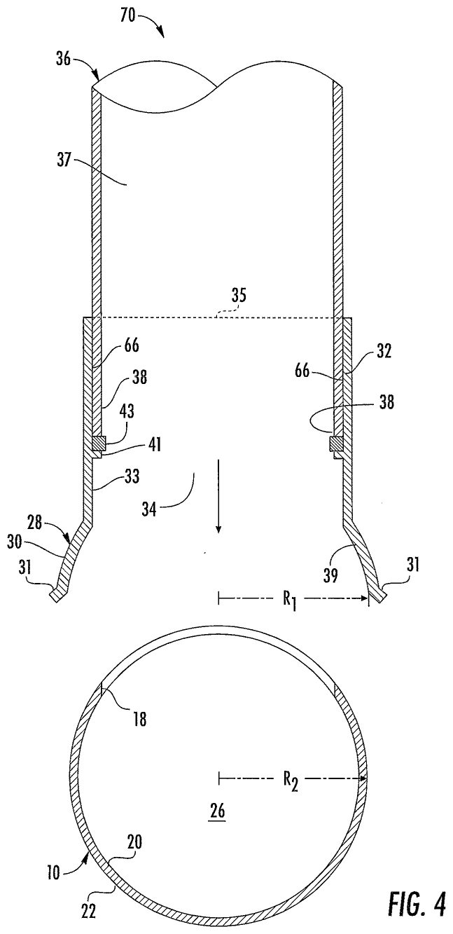

In embodiments where the curved plate 30 does not extend beyond the spring line of the pipe 10, the radius R1 of curvature of the curved plate 30 may be somewhat less than the radius of curvature R2 of the outer surface 22 of the sewer pipe 10 (see FIG. 4). The material of curved plate 30 is flexible and resilient so that it can be expanded to the radius of curvature R2 of the outer surface 22 of the sewer pipe 10 when the curved plate 30 is expanded or flexed to engage the pipe 10 as shown in FIGS. 3 and 4. Because the curved plate 30 initially has a radius R1 of curvature less than the radius R2 of curvature of the outer surface of the pipe 10 in this embodiment, when the curved plate 30 is flexed and pushed down on top of the pipe 10, the curved plate 30 provides a pinching or clamping action around the outer surface of the pipe 10.

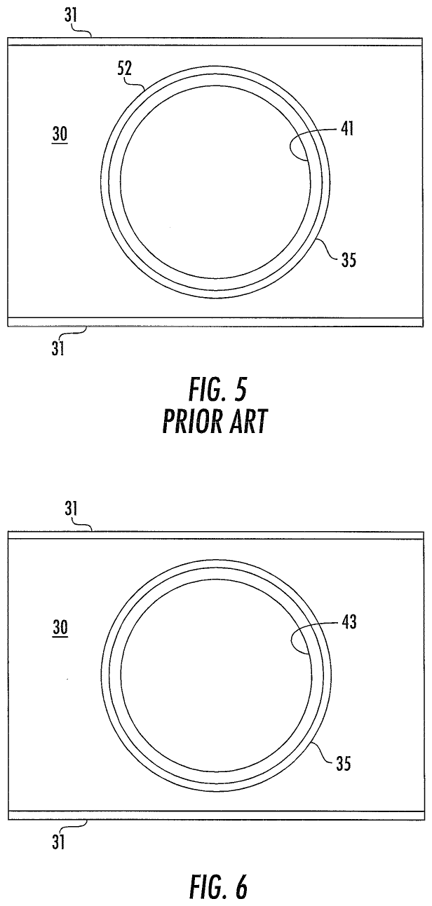

Although the pipe 10 is discussed in the context of having a circular shape, it is to be understood that the pipe 10 need only have a substantially circular cross-section and not necessarily a perfectly circular cross-section. The curved plate 30 having a concave surface 39 is operably connected to the outer surface 22 of the pipe 10 along an arc of the outer surface of the pipe 10. An extension pipe 36 has an extension pipe bore 37 extending therethrough. The extension pipe 36 has a first end 38 telescoped with respect to upper end 35 of boss bore 34. The first end 38 rests on an annular flange 41 protruding inwardly from an inner surface of the boss 32 at approximately a tangent to sewer pipe 10, although it could be higher or lower. A gasket 43 is combined with the flange 41 so that the gasket 43 is positioned between the flange 41 and the first end 38 of the extension pipe 36. FIG. 6 shows a top view looking into the boss 32 before the extension pipe 36 is attached. FIG. 6 shows the gasket 43 visible since it is attached to the flange 41 and adapted to engage or seat the extension pipe 36. The gasket 43 may be a single band of material. The gasket 43 provides a seal between the boss 32 and the extension pipe 36. The gasket 43 may be combined with the flange 41 by any suitable means, including by using an adhesive. The gasket 43 may be made from any suitable compressible material, including a hydrophilic material, a hydrophobic material, and an absorbent material. A hydrophilic material is capable of expanding or swelling in response to being exposed to a liquid, such as water, and forms a seal between the boss 32 and the extension pipe 36.

In some embodiments the gasket 43 is a hydrophilic caulk or paste applied around the surface of the flange 41. This product is a single component hydrophilic paste used in water stop repairs. The gasket 43 may also be made from a paste that is not hydrophilic yet forms an impermeable compressible gasket when cured. Like the pre-formed gasket 43 described above, the caulk or paste gasket 43 is adapted to engage or seat the first end 38 of the extension pipe 36. In other embodiments the caulk or paste may be applied around the upper or terminal end of the boss 32 to help seal the connection between the extension pipe 36 and the boss 32.

In operation, the excavated hole 24 is dug down to the sewer pipe 10 buried beneath the surface of the ground 14. This can all be done above ground remotely from the location of the sewer pipe 10 and does not require the installer to enter the excavated hole 24. The preferred method is to use a vacuum excavator. This device excavates a hole and removes the soil 12 from the hole with a minimum of disturbance of the soil 12. The diameter D1 of the hole need be only large enough to permit the insertion of the curved plate 30 into the hole, and need be only deep enough to expose a portion of the outer surface of sewer pipe 10.

The entire assembly 70 includes the extension pipe 36, the saddle or curved plate 30, the boss 32, and the gasket 43 between the flange 41 of the boss and the extension pipe 36. The assembly 70 may also include an adhesive 66 or other material to help secure the components together. Before curved plate 30 engages the sewer pipe 10, the adhesive 66 is applied between curved plate 30 and the outer surface 22 of sewer pipe 10 and/or between the boss 32 and the extension pipe 36. All this is assembled above the excavated hole 24 before lowering within the excavated hole 24. Once the assembly is lowered into the excavated hole 24, the operator pushes on the extension pipe 36 to cause the curved plate 30 to expand and to surround the outer surface 22 of the sewer pipe 10. At this time the fluid tight seal is provided by the gasket 43 between the telescoped upper end 35 of the boss bore 34 and the first end 38 of the extension pipe 36. An aperture 18 is then cut within the sewer pipe 10 to provide access from the top of the extension pipe 36 (usually at ground surface 14) to the sewer bore 26 within the sewer pipe 10. Any suitable cutting machine may be used to create the aperture 18 in the pipe 10.

In the drawings and specification there has been set forth a preferred embodiment of the invention, and although specific terms are employed, these are used in a generic and descriptive sense only and not for purposes of limitation. Changes in the form and the proportion of parts as well as in the substitution of equivalents are contemplated as circumstance may suggest or render expedient without departing from the spirit or scope of the invention as further defined in the following claims.

What is claimed is as follows:

1. An apparatus for providing access to an interior bore of a pipe located below a surface of the ground using an extension pipe having a first end, the apparatus comprising:
a curved plate adapted to engage an outer surface of the pipe, the curved plate having an interior surface adapted to be placed against the pipe; and
a boss extending from an aperture in the curved plate and having a boss bore therethrough;
a flange extending inwardly from an inner surface of the boss; and
a gasket combined with the flange and adapted to engage the first end of the extension pipe.

2. The apparatus of claim 1 wherein the gasket is a hydrophilic or hydrophobic material.

3. The apparatus of claim 1 wherein the gasket is a hydrophilic paste.

4. The apparatus of claim 1 wherein the gasket is a hydrophilic material capable of swelling in response to being exposed to a liquid.

5. The apparatus of claim 1 wherein the gasket is combined with the flange of the boss by an adhesive.

6. The apparatus of claim 1 wherein the curved plate comprises an arc having a length less than a length of an arc corresponding to 180° of an outer surface of the pipe.

7. The apparatus of claim 1 wherein the curved plate has a radius of curvature less than a radius of curvature of the pipe to bias the plate against the pipe.

8. The apparatus of claim 1 further comprising flanges extending from the outer tips of the curved plate away from the pipe.

9. The apparatus of claim 1 wherein the extension pipe is telescopically mounted to the boss.

10. The apparatus of claim 1 further comprising an adhesive material disposed between the boss and the extension pipe.

11. The apparatus of claim 1 wherein there is more than one boss extending from the aperture in the curved plate.

12. The apparatus of claim 1 further comprising an adhesive material disposed between the surface of the curved plate and the outer surface of the pipe.

13. A method of providing access to an interior bore of a pipe buried beneath a surface of the ground, the pipe having an outer surface, the method comprising:
excavating the ground to expose a portion of the pipe;
taking an assembly comprising a curved plate adapted to engage the outer surface of the pipe, a boss extending from an aperture in the curved plate and away from the pipe and having a flange extending inwardly from a boss bore, an extension pipe telescopically mounted with the boss bore and extending away from the curved plate, and a gasket between the flange of the boss and the extension pipe;
attaching the assembly to the pipe by placing the curved plate about the outer surface of the pipe; and
making an access hole in the pipe aligned with the aperture of the curved plate.

14. The method of claim 13 further comprising applying an adhesive material between the boss and the extension pipe.

15. The method of claim 13 wherein the excavating step is performed using vacuum excavation.

16. The method of claim 13 further comprising:
applying an adhesive material to the concave surface of the curved plate before attaching the pipe access device to the pipe; and
allowing the sealing material to cure and harden after attaching the pipe access device to the pipe.

17. The method of claim 13 wherein the curved plate of the assembly covers less than 180° of the pipe when the assembly has been attached to the pipe.

18. An apparatus for providing access to an interior bore of a pipe located below a surface of the ground, the pipe having an outer surface, the apparatus comprising:
a device comprising a curved plate having a radius of curvature less than the radius of curvature of the pipe and a boss extending from the curved plate about an aperture in the plate, the boss comprising a bore having an inner surface with a annular flange extending inwardly therefrom;
an extension pipe extending from the boss away from the curved plate, said extension pipe having a first end; and
a hydrophilic gasket combined with the flange and positioned between the flange and the first end of the extension pipe.

19. The apparatus of claim 18 wherein the gasket is combined with the flange of the boss by an adhesive.

20. The apparatus of claim 18 wherein the curved plate comprises an arc having a length less than a length of an arc corresponding to 180° of the outer surface of the pipe.

21. The apparatus of claim 18 wherein the curved plate has a radius of curvature less than the radius of curvature of the pipe to bias the plate against the pipe.

22. The apparatus of claim 18 further comprising flanges extending from the outer tips of the curved plate away from the pipe.

22. The apparatus of claim 18 wherein the extension pipe is telescopically mounted to the boss.

24. The apparatus of claim 18 wherein there is more than one boss extending from the aperture in the curved plate.
